(19) United States
(12) Patent Application Publication
(10) Pub. No.: US 2003/0224159 A1
(43) Pub. Date: Dec. 4, 2003

(54) Hand-tearable adheasive tape with a tear-propagating film backing

(75) Inventor: Christof-Gottfried Hoelger, Hohberg (DE)

Correspondence Address: Norris, McLaughlin & Marcus P.A., 30th Floor, 220 East 42nd Street, New York, NY, 10017, US

(73) Assignee: TESA AG, Hamburg (DE)

(21) Appl. No.: 10/391,224

(22) Filed: Mar. 18, 2003

(30) Foreign Application Priority Data
May 28, 2002 (DE) 102 23 634.8

(51) Int. Cl. B32B 7/12

(52) U.S. Cl. 428/343; 428/353; 428/354

(57) ABSTRACT

An adhesive tape having a film backing material in which a tear can be propagated transversely with respect to the direction from which individual lengths of the tape are taken, an adhesive being applied to one or both sides of said backing material, and one of the two longitudinal edges having a rough cut edge such that over the entire area there are notches in a frequency of at least 1/mm, the notches being disposed irregularly and differing in depth, and the other longitudinal edge being substantially smooth and having no such notches or a greatly reduced number thereof.

### BACKGROUND OF THE INVENTION

The present invention relates to the use of an adhesive tape comprising a tear-propagating film backing material to one or both sides of which an adhesive has been applied.

Important properties for the use of adhesive tapes include easy hand or manual tearability when removing a length of tape from the roll prior to bonding, and residue-free, rapid and easy removability of the adhesive tape after use.

While the residue-free removability may be attributed, inter alias, to the adhesive or other functional layers of the adhesive tape, tensile strength and hand tearability are based substantially on the physical attributes of the backing material used—for example, the stretchability and the tensile strength.

Materials with a low tensile strength tend to tear when the adhesive tape is removed, and so make this operation much more difficult.

In self-adhesive tapes for everyday applications such as fixing, bundling, marking, repairing, sealing or closing, the use of textile backing materials is commonplace. The textile backing ideally combines the properties of high tensile strength with good hand tearability. Restrictions on the use of the textile backings frequently arise as a result of their price and their thickness.

For adhesive masking tapes in the painting and decorating sector it is preferred to use impregnated paper backings, specifically those which are equipped with a defined tensile strength as a result of the basis weight of the backing, the nature of the pulp used, the degree of freeness, and certain chemical auxiliaries, and are equipped with a defined stretchability as a result of particular process steps such as creping or the Clupak process.

Paper backings generally have very good manual tearability. Restrictions on the use of paper backings frequently arise as a result of the strongly reduced strength of the paper backings under the effects of moisture, including those for example in the outdoor sector; furthermore, paper backings are disadvantageous when the quality of the paint edge necessitates a very low thickness of the backing.

Embossed PVC films do find application as masking tape in the decorating sector; the film exhibits a pronounced moisture resistance which is particularly useful for use outdoors. The embossing of the film ensures its hand tearability and makes it much easier to use.

Furthermore, thin films are used as so-called plaster tapes, the adhesive tapes can be torn in two by hand. Thin films with low tensile strength, high elongation, and the resulting tendency toward necking in are disadvantageous for masking, owing to the absence of dimensional stability; moreover, they are highly stretched at the tearing site and have a severely deformed, corrugated torn edge, which is disadvantageous for aesthetic reasons and also for their use as painting or decorating tape.

In the painting sector, adhesive tapes with a film backing (for example, tesa® 4104) are used as painting or masking tape, especially when exacting requirements are imposed on the paint edge. Due to the lack of hand tearability, it is necessary to use auxiliary means to remove lengths of the tape during application.

For these applications, films of which lengths can be removed easily by hand owing to their low elongation and tensile strength are also known as backings for adhesive tapes (tesa®) 7164, fineline range). These films, however, are very expensive.

DE 43 18 277 C1 disclosed the use of jagged cutters for the longitudinal cutting of double-face self-adhesive tapes with PP backings, which find use in particular as carpet-laying tape. The jags of the jagged cutter preferably have a height of from 0.3 to 6 mm, in particular from 0.4 to 1 mm. As a result of the jaggedness thereby produced in the cut edge, the hand tearability of the adhesive tape is enhanced. The use in the painting and decorating sector, of course, jagged edges of this kind are unsuitable owing to their unwanted reproduction in the paint edge. Furthermore, adhesive tapes of this kind tend toward soiling on storage. Finally, the jagged cutters are costly and inconvenient to manufacture, as a result of which the products produced using them are also expensive.

It is an object of the invention to provide an adhesive tape having firstly good hand tearability and secondly a high strength, particularly in the context of tearing-free removal of the adhesive tape following use, said adhesive tape not having the prior art drawbacks illustrated.

### SUMMARY OF THE INVENTION

This object is achieved for the use of an adhesive tape as specified in the independent claim. The dependent claims relate to advantageous developments of the subject matter of the invention.

The invention accordingly provides an adhesive tape having a film backing material in which a tear can be propagated transversely with respect to the direction from which individual lengths of the tape are taken, an adhesive being applied to one or both sides of said backing material, and one of the two longitudinal edges having a rough cut edge such that over the entire area there are notches in a frequency of at least 1/mm, the notches being disposed irregularly and differing in depth, and the other longitudinal edge being substantially smooth and having no such notches or a greatly reduced number thereof.

### BRIEF DESCRIPTION OF THE DRAWINGS

FIG. 1 is a cross-section through an adhesive tape having notches to ensure improved manual tearing.

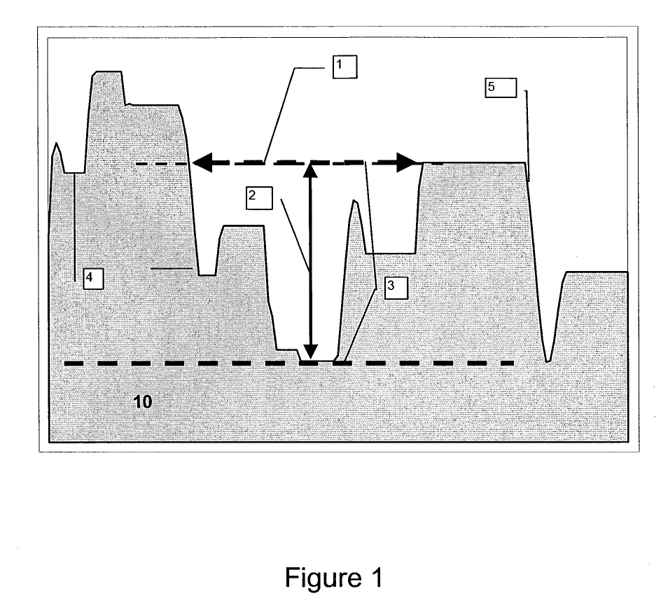

### DETAILED DESCRIPTION OF THE PRESENTLY PREFERRED EMBODIMENTS

Notching in the border area of the adhesive tape 10, in other words at the cut edge 5, has a curved or zigzag course which is uneven, exhibiting local minima and local maxima, and is described here by means of a width 1 and an associated depth 2. The depth 2 of a notch is used here to refer to the distance between two straight lines running parallel in the longitudinal direction of the adhesive tape, with one straight line passing through a minimum and the second through a maximum. In the case of a uniformly sinusoidal course, one straight line passes in each case through two or more adjacent local minima 4 or maxima.

In the case of an irregular course, this is normally not the case: the depth of a notch is described by a straight line which passes only through one single maximum. The width occupied by a notch is the distance between the points of intersection of the straight lines through a maximum, on the one hand, and with the longitudinal edge of the adhesive tape, on the other. The depth of a notch having a certain width relates naturally to the minimum with the greatest distance between the points of intersection.

In a first advantageous embodiment of the invention, larger and smaller notches are present, the larger notches having with particular preference a depth of from 15 to 100 μm and the smaller notches having with particular preference a depth of from 5 to 15 μm.

In another advantageous embodiment of the invention, the larger notches are arranged with a frequency of from 1 to 10/mm of edge and/or the smaller notches are arranged with a frequency of from 5 to 30/mm of edge.

In another advantageous embodiment of the invention, the tear propagation force of the film, as described by the tear propagation force determined on trouser-shaped test specimens (EN ISO 13937-2 with a 100 mm/min advance speed), is advantageously <10 N, in particular less than 1 N.

The notches ensure improved manual tearability of the edge with the notches and thus easier manual tearability of the entire tape in the transverse direction (relative to the direction in which the adhesive tape extends), allowing the user to tear off the tape without exerting a high force and without the assistance of tools such as scissors or cutters following application. The result is a considerable time saving in the processing operation. The irregularity of the notches means that they are inconspicuous and already so small that they are difficult, if not impossible, to see with the naked eye, thereby avoiding any unwanted effects in terms of aesthetics. Naturally, this side has an increased susceptibility to tearing on removal. Through the removal of the adhesive tape from the side with the smooth cut edge, this susceptibility is greatly reduced.

Surprisingly, and completely unexpectedly for one skilled in the art, an adhesive tape with a tear-propagating film backing material where one of the two longitudinal edges has a rough cut edge such that over the entire area there are notches having a depth of from 15 μm to 100 μm in a frequency of at least 1/mm exhibits an outstanding and selective combination of the properties of excellent hand tearability on the one hand and good backing strength during removal on the other.

As material for the film it is preferred to use BOPP, MOPP, PVC or PET, which in a particularly advantageous embodiment of the invention additionally has a thickness of from 20 to 100 μm, in particular from 30 to 60 μm.

All of the films listed can be used as backing film in accordance with the invention. One advantageous embodiment of the invention is represented by a film which is colored and/or nontransparent.

One outstanding embodiment of the invention is then that wherein the film has been provided with a pressure sensitive adhesive.

In another advantageous embodiment of the invention, the adhesive application rate is from 15 to 40 g/m², more preferably from 15 to 120 g/m².

With particular preference, the film is printed, especially when only one longitudinal edge is provided with the notches, in order, for example, to call the attention of the user of the adhesive tape to the edge which is easy to tear.

The adhesive tape possesses a low thickness, a high tensile strength (ultimate tensile stress strength), good stretchability (elongation at break), a sufficient but not excessive bond strength, a high water resistance, and very good resistance to paint penetration and moisture, a measured bond strength to its own reverse face, and excellent hand tearability.

The adhesive of the adhesive tapes of the invention may comprise a self-adhesive from the group of natural rubbers or of synthetic rubbers or of any desired blend of natural rubbers and/or synthetic rubbers, the natural rubber or rubbers being selectable in principle from all available grades such as, for example, crepe, RSS, ADS, TSR or CV grades, depending on the required level of purity and viscosity, and the synthetic rubber or rubbers being selectable from the group consisting of randomly copolymerized styrene-butadiene rubbers (SBR), butadiene rubbers (BR), synthetic polyiosprenes (IR), butyl rubbers (IIR), halogenated butyl rubbers (XIIR), acrylate rubbers (ACM), ethylene-vinyl acetate (EVA) copolymers, and polyurethanes and/or blends thereof.

With further preference, in order to improve the processing properties, thermoplastic elastomers may be added to the rubbers in a weight fraction of from 10 to 50% by weight, based on the total elastomer fraction.

As representatives, mention may be made at this point in particular of the especially compatible styrene-isoprene-styrene (SIS) and styrene-butadiene-styrene (SBS) grades.

As tackifier resins it is possible without exception to use all known tackifier resins and all tackifier resins described in the literature. As representatives, mention may be made of the rosins, their disproportionated, hydrogenated, polymerized and esterified derivatives and salts, the aliphatic and aromatic hydrocarbon resins, terpene resins, and terpene-phenolic resins. Any desired combinations of these and further resins may be used in order to tailor the properties of the resulting adhesive. Express reference may be made to the depiction of the state of art in the “Handbook of Pressure Sensitive Adhesive Technology” by Donatas Satas (van Nostrand, 1989).

Crosslinking is advantageous for improving the removability of the adhesive tape following application, and may be effected thermally or by irradiation with UV light or electron beams. For the purpose of thermally induced chemical crosslinking it is possible to use all known heat-activatable chemical crosslinkers such as accelerating sulfur systems or sulfur donor systems, isocyanate systems, reactive melamine resins, formaldehyde resins and (optionally halogenated) phenol-formaldehyde resins or reactive phenolic resin systems or diisocyanate crosslinking systems with the corresponding activators, epoxidized polyester resins and acrylate resins, and combinations thereof.

The crosslinkers are preferably activated at temperatures above 50° C., in particular at temperatures from 100° C. to 160° C., with very particular preference at temperatures from 110° C. to 140° C.

Thermal excitation of the crosslinkers may also take place by IR radiation or by means of high-energy alternating fields.

It has proven particularly advantageous to use an adhesive based on acrylate hotmelt which has a K value of at least 20, in particular more than 30, obtainable by concentrating a solution of such an adhesive to give a system which can be processed as a hot melt.

Concentration may take place in appropriately equipped tanks or extruders; particularly when devolatilization accompanies the concentration process, a devolatilization extruder is preferred. An adhesive of this kind is specified in DE 43 13 008 A1, the content of which is hereby incorporated by reference to become part of this disclosure and invention. In an intermediate step, the solvent is removed completely from the acrylate compositions prepared in this way. Additionally, further volatile constituents are removed. After coating from the melt, these compositions contain only minimal fractions of volatile constituents. It is therefore possible to adopt all of the monomers/formulations claimed in the patent set out above. A further advantage of the compositions described in the patent is regarded as being the fact that they have a high K value and thus a high molecular weight. The skilled worker is aware that systems with higher molecular weights can be crosslinked more efficiently. There is a corresponding reduction in the fraction of volatile constituents.

The solution of the composition may contain from 5 to 80% by weight, in particular from 30 to 70% by weight, of solvent(s).

Preference is given to using commercially customary solvents, especially low-boiling hydrocarbons, ketones, alcohols and/or esters.

Further preference is given to using single-screw, twin-screw or multi-screw extruders having one or, in particular, two or more devolatilizing units.

Benzoin derivatives may have been copolymerized into the adhesive based on acrylate hotmelt, such as benzoin acrylate or benzoin methacrylate, acrylic or methacrylic esters, for example. Benzoin derivatives of this kind are described in EP 0 578 151 A1.

Alternatively, the adhesive based on acrylate holtmelt may have been crosslinked chemically. In one particularly preferred embodiment, the self-adhesives used are copolymers of (meth)acrylic acid and esters thereof having 1 to 25 carbon atoms, maleic, fumaric and/or itaconic acid and/or their esters, substituted (meth)acrylamides, maleic anhydride and other vinyl compounds, such as vinyl esters, especially vinyl acetate, vinyl alcohols and/or vinyl ethers.

The residual solvent content ought to be below 1% by weight.

An adhesive which is found particularly suitable is a low molecular mass acrylate holtmelt pressure sensitive adhesive as supplied under the name acResin UV or Acronal®), especially Acronal® DS 3458, by BASF. This low-K adhesive acquires its application-compatible properties by virtue of a final crosslinking which is initiated chemically by radiation.

Where appropriate, a release varnish may be applied to the reverse face in order to improve the unwind properties.

In certain cases, conversely, the reverse face may be treated with a corona or with a varnish for the purpose of improving the adhesion of an ink to the reverse face.

It is advantageous to use a primer layer between backing film and adhesive for the purpose of improving the adhesion of the adhesive to the film and hence of allowing the system to be removed again without residue after use.

Descriptions of the adhesives commonly used for adhesive tapes, and also of release varnishes and primers, can be found, for example, in the “Handbook of Pressure Sensitive Adhesive Technology” by Donatas Satas (van Nostrand, 1989).

The content of said handbook is hereby incorporated by reference to become part of this disclosure and invention.

A single-sided adhesive tape where the application rate of adhesive is preferably between 15 and 30 g/m² can be used with particular advantage as an adhesive packaging tape.

The adhesive packaging tapes feature, in particular, running lengths of 66, 100 and 1000 m. Common roll widths selected are 18, 24, 36, 48, 50, and 72 mm.

The preferred colors are brown, white, and transparent. Printing takes place on rolls of 144 or 150 mm in width, which are subsequently slit to the abovementioned widths.

What is claimed is:

1. A manually tearable adhesive tape comprising
a film backing material having a first and a second side, and being capable of propagating a tear transversely with respect to the direction of the lengths of the tape;
an adhesive being applied to at least one of the first side and the second side of the backing material;
the tape having a first and a second longitudinal edge, the first longitudinal edge having a rough-cut edge such as to provide notches in a frequency of at least 1 per mm, the notches being disposed in irregular intervals and having irregular depth, the second longitudinal edge being substantially smooth and having substantially no notches or a greatly reduced number of notches.

2. The adhesive tape as claimed in claim 1, wherein the irregular depth of the notches along the rough-cut edge have a depth of about 15 to 100 μm for forming large notches and a depth of about 5 to 15 μm for forming small notches

3. The adhesive tape as claimed in claim 2, wherein the large notches are arranged in a frequency of about 1 to 10 per mm and the small notches are arranged with a frequency of about 5 to 30 per mm.

4. The adhesive tape as claimed in claim 1, wherein a tear propagation force applied for manually tearing the adhesive tape is in average less than 10 N is.

5. The adhesive tape as claimed in claim 4, wherein a tear propagation force applied for manually tearing the adhesive tape is less than 1 N.

6. The adhesive tape as claimed in claim 1, wherein film backing material is one of PVC, BOPP, MOPP and PET.

7. The adhesive tape as claimed in claim 1, wherein the film backing material has a thickness of about 20 to 100 μm

8. The adhesive tape as claimed in claim 7, wherein the film backing material has a thickness of about 30 to 50 μm.

9. The adhesive tape as claimed in claim 1, wherein the film includes printing on the first or the second side

10. The adhesive tape as claimed in claim 9, wherein the film includes a primer for anchoring printing.

11. The adhesive tape as claimed in claim 1, wherein the adhesive tape includes printing disposed between the film and the adhesive.

12. The adhesive tape as claimed in claim 10, wherein at least one of the adhesive, the primer, and the film is colored.

13. The adhesive tape as claimed in claim 10, wherein at least one of the adhesive, the primer, and the film is nontransparent.

14. The adhesive tape as claimed in claim 10, wherein at least one of the adhesive, the primer, and the film is colored and nontransparent.

15. A method for manually tearing adhesive tape comprising
providing a film backing material having a first and a second side;
providing an adhesive layer being applied to at least one of the first side and the second side of the backing material;
the tape having a first and a second longitudinal edge, the first longitudinal edge having a rough-cut edge such as to provide notches in a frequency of at least 1 per mm, the notches being disposed in irregular intervals and having irregular depth, the second longitudinal edge being substantially smooth and having substantially no notches or a greatly reduced number of notches;
wherein the tape being capable of propagating a tear transversely with respect to the direction of the lengths of the tape.
